(19) United States
(12) Patent Application Publication
(10) Pub. No.: US 2025/0219667 A1
(43) Pub. Date: Jul. 3, 2025

(54) SIGNAL TRANSMISSION METHOD, APPARATUS, AND COMMUNICATION DEVICE

(71) Applicant: VIVO MOBILE COMMUNICATION CO., LTD., Dongguan (CN)

(72) Inventors: Rongling JIAN, Dongguan (CN); Kai WU, Dongguan (CN); Junjie TAN, Dongguan (CN)

(21) Appl. No.: 19/082,993

(22) Filed: Mar. 18, 2025

Related U.S. Application Data
(63) Continuation of application No. PCT/CN2023/119481, filed on Sep. 18, 2023.

(30) Foreign Application Priority Data
Sep. 22, 2022 (CN) 202211158920.7

(51) Int. Cl. H04B 1/10; H04W 28/18

(52) U.S. Cl. CPC H04B 1/1027; H04W 28/18

(57) ABSTRACT

A signal transmission method and apparatus, and a communication device are disclosed relating to communication technologies. The signal transmission method according to embodiments of this application includes: sending, by a target communication device, a first carrier signal and a second carrier signal, where a frequency of the first carrier signal is different from a frequency of the second carrier signal; and receiving, by the target communication device, a backscatter signal, where the backscatter signal is obtained based on the first carrier signal and the second carrier signal.

### CROSS-REFERENCE TO RELATED APPLICATIONS

This application is a bypass continuation application of International Application No. PCT/CN2023/119481, filed on Sep. 18, 2023, which claims the benefit of and priority to Chinese Patent Application No. 202211158920.7, filed on Sep. 22, 2022 and entitled “SIGNAL TRANSMISSION METHOD AND APPARATUS, AND COMMUNICATION DEVICE”, both of which are incorporated by reference in their entireties herein.

### TECHNICAL FIELD

This application relates to the field of communication technologies and, in particular, relates to a signal transmission method and apparatus, and a communication device.

### BACKGROUND

For a reader (Reader) in a communications system, a single antenna being connected to a circulator (or a directional coupler) or multiple antennas transmitting and receiving at the same time can perform a frequency division duplex (Frequency Division Duplex, FDD) communication mode of radio frequency identification (Radio Frequency Identification, RFID).

### BRIEF SUMMARY

Embodiments of this application provide a signal transmission method and apparatus, and a communication device.

According to a first aspect, a signal transmission method is provided, including:
sending, by a target communication device, a first carrier signal and a second carrier signal, where a frequency of the first carrier signal is different from a frequency of the second carrier signal; and
receiving, by the target communication device, a backscatter signal, where the backscatter signal is obtained based on the first carrier signal and the second carrier signal.

According to a second aspect, a signal transmission method is provided, including:
receiving, by a third communication device, a first carrier signal and a second carrier signal, where a frequency of the first carrier signal is different from a frequency of the second carrier signal;
generating, by the third communication device, a backscatter signal based on the first carrier signal and the second carrier signal; and
sending, by the third communication device, the backscatter signal.

According to a third aspect, a signal transmission method is provided, including:
receiving, by a fourth communication device, a first carrier signal and a second carrier signal, where a frequency of the first carrier signal is different from a frequency of the second carrier signal; and
receiving, by the fourth communication device, a backscatter signal, where the backscatter signal is obtained based on the first carrier signal and the second carrier signal.

According to a fourth aspect, a signal transmission apparatus is provided, including:
a first signal sending module, configured to send a first carrier signal and a second carrier signal, where a frequency of the first carrier signal is different from a frequency of the second carrier signal; and
a first signal receiving module, configured to receive a backscatter signal, where the backscatter signal is obtained based on the first carrier signal and the second carrier signal.

According to a fifth aspect, a signal transmission apparatus is provided, including:
a second signal receiving module, configured to receive a first carrier signal and a second carrier signal, where a frequency of the first carrier signal is different from a frequency of the second carrier signal;
a processing module, configured to generate a backscatter signal based on the first carrier signal and the second carrier signal; and
a second signal sending module, configured to send the backscatter signal.

According to a sixth aspect, a signal transmission apparatus is provided, including:
a third signal receiving module, configured to receive a first carrier signal and a second carrier signal, where a frequency of the first carrier signal is different from a frequency of the second carrier signal; and
a fourth signal receiving module, configured to receive a backscatter signal, where the backscatter signal is obtained based on the first carrier signal and the second carrier signal.

According to a seventh aspect, a communication device is provided, including a processor and a memory, where the memory stores a program or an instruction that can be run on the processor, and the program or the instruction is executed by the processor to implement the steps of the method according to the first aspect, the second aspect, or the third aspect.

According to an eighth aspect, a signal transmission system is provided, including a target communication device, a third communication device, and a fourth communication device. The target communication device may be configured to perform the steps of the signal transmission method according to the first aspect, the third communication device may be configured to perform the steps of the signal transmission method according to the second aspect, and the fourth communication device may be configured to perform the steps of the signal transmission method according to the third aspect.

According to a ninth aspect, a readable storage medium is provided. The readable storage medium stores a program or an instruction. When the program or the instruction is executed by a processor, the steps of the method according to the first aspect are implemented, the steps of the method according to the second aspect are implemented, or the steps of the method according to the third aspect are implemented.

According to a tenth aspect, a chip is provided, where the chip includes a processor and a communication interface, the communication interface is coupled to the processor, and the processor is configured to run a program or an instruction, to implement the method according to the first aspect, the method according to the second aspect, or the method according to the third aspect.

According to an eleventh aspect, a computer program/program product is provided, the computer program/program product is stored in a storage medium, and the computer program/program product is executed by at least one processor to implement the steps of the method according to the first aspect, the second aspect, or the third aspect.

According to a twelfth aspect, an embodiment of this application provides a signal transmission apparatus, and the apparatus is configured to perform the steps of the method according to the first aspect, the second aspect, or the third aspect.

### BRIEF DESCRIPTION OF DRAWINGS

FIG. 1 is a block diagram of a wireless communication system to which embodiments of this application are applicable;

FIG. 2 is a first schematic diagram of backscatter communication according to an embodiment of this application;

FIG. 3 is a second schematic diagram of backscatter communication according to an embodiment of this application;

FIG. 4 is a schematic diagram of an application scenario of backscatter communication according to an embodiment of this application;

FIG. 5 is a flowchart of a signal transmission method according to an embodiment of this application;

FIG. 6 is a schematic diagram of a spectrum of an output signal obtained after a first carrier signal and a second carrier signal are input to a non-linear component according to an embodiment of this application;

FIG. 7 is a schematic diagram of a 3rd order intermodulation distortion IMD according to an embodiment of this application;

FIG. 8 is a flowchart of another signal transmission method according to an embodiment of this application;

FIG. 9 is a flowchart of another signal transmission method according to an embodiment of this application;

FIG. 10 is a schematic diagram of a signal transmission procedure in Implementation 1 and spectrums in different stages according to an embodiment of this application;

FIG. 11 is a schematic diagram of a signal transmission procedure in Implementation 2 and spectrums in different stages according to an embodiment of this application;

FIG. 12 is a structural block diagram of a signal transmission apparatus according to an embodiment of this application;

FIG. 13 is a structural block diagram of another signal transmission apparatus according to an embodiment of this application;

FIG. 14 is a structural block diagram of another signal transmission apparatus according to an embodiment of this application;

FIG. 15 is a structural block diagram of a communication device according to an embodiment of this application;

FIG. 16 is a structural block diagram of a terminal according to an embodiment of this application;

FIG. 17 is a structural block diagram of a network side device according to an embodiment of this application; and

FIG. 18 is a structural block diagram of another network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (Long Term Evolution, LTE)/LTE-Advanced (LTE-Advanced, LTE-A) system, and may be further applied to other wireless communication systems such as Code Division Multiple Access (Code Division Multiple Access, CDMA), Time Division Multiple Access (Time Division Multiple Access, TDMA), Frequency Division Multiple Access (Frequency Division Multiple Access, FDMA), Orthogonal Frequency Division Multiple Access (Orthogonal Frequency Division Multiple Access, OFDMA), single-carrier frequency division multiple access (Single-carrier Frequency Division Multiple Access, SC-FDMA), and other systems. The terms “system” and “network” in the embodiments of this application may be used interchangeably. The technologies described can be applied to both the systems and the radio technologies mentioned above as well as to other systems and radio technologies. A new radio (New Radio, NR) system is described in the following description for illustrative purposes, and the NR terminology is used in most of the following description, although these technologies can also be applied to applications other than the NR system application, such as the 6^{th} generation (6^{th} Generation, 6G) communication system.

In a Reader according to an example of the present disclosure, when the single antenna is used, a carrier at a transmit end leaks, and when two antennas are used, coupling effect of antennas at the transmit end, coupling between circuits, and mismatch of transmit antennas lead to signal reflection, environmental signal reflection, and the like. This causes interference to a backscatter signal, and the interference needs to be eliminated or suppressed through the RFID self-interference elimination technology.

Specific methods for the Reader to eliminate/suppress the self-interference include the following:
Method 1: Antenna domain interference elimination/suppression, that is, it is mainly used in a scenario of realizing FDD with multiple antennas, and a specific method includes measures such as isolating the transmitting and receiving antennas by increasing a distance, and physically isolating the transmitting and receiving antennas by using a baffle;
Method 2: Analog domain interference elimination/suppression, that is, the RFID self-interference is eliminated/suppressed by adding an RF circuit;
Method 3: Digital domain interference elimination/suppression, that is, similar to the analog domain, the self-interference of RFID is eliminated/suppressed by adding a baseband circuit; and
Method 4: Using a filter to filter out out-of-band noise, and transmitting control signaling to a tag (Tag) to keep silent for a fixed period of time.

Therefore, when the Reader eliminates/suppresses the self-interference, a segregation board needs to be added, an antenna distance needs to be increased, or an additional analog interference elimination/suppression circuit or a baseband circuit needs to be configured. However, adding of the interference elimination/suppression circuit may reduce power efficiency of a radio frequency front-end and increase hardware design costs.

In addition, it is difficult to eliminate/suppress the self-interference by using the method of analog/baseband circuit because an energy of the backscatter signal is weak, while an energy of a leaked/coupled carrier signal is strong, and a frequency point of the backscatter signal is basically consistent with that of the carrier signal.

Therefore, in an example of the disclosure, the analog/baseband circuit is added to eliminate the self-interference of the Reader, however, this not only increases hardware costs, but also has poor elimination or suppression effect.

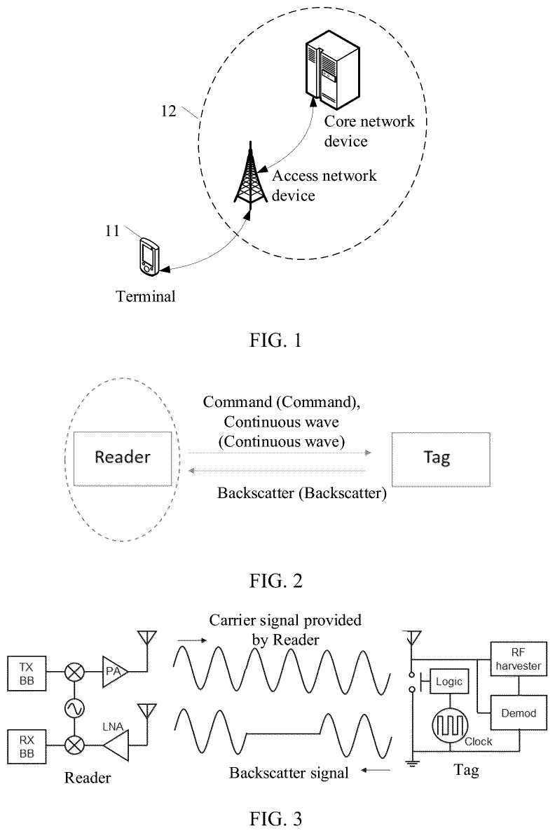

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer (Tablet Personal Computer), a laptop computer (Laptop Computer) or a notebook computer, a personal digital assistant (Personal Digital Assistant, PDA), a palmtop computer, a netbook, an ultra-mobile personal computer (ultra-mobile personal computer, UMPC), a mobile internet device (Mobile Internet Device, MID), an augmented reality (augmented reality, AR)/virtual reality (virtual reality, VR) device, a robot, a wearable device (Wearable Device), vehicle user equipment (VUE), pedestrian user equipment (PUE), a smart home (a home device with a wireless communication function, such as a refrigerator, a television, a washing machine, or a furniture), a game console, a personal computer (personal computer, PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. It should be noted that a specific type of the terminal 11 is not limited in the embodiments of this application. The network side device 12 may include an access network device or a core network device. The access network device 12 may also be referred to as a radio access network device, a radio access network (Radio Access Network, RAN), a radio access network function, or a radio access network unit. The access network device 12 may include a base station, a WLAN access point, a Wi-Fi node, or the like. The base station may be referred to as a NodeB, an evolved NodeB (eNB), an access point, a base transceiver station (Base Transceiver Station, BTS), a radio base station, a radio transceiver, a basic service set (Basic Service Set, BSS), an extended service set (Extended Service Set, ESS), a home NodeB, a home evolved NodeB, a transmitting receiving point (Transmitting Receiving Point, TRP), or another appropriate term in the field. As long as a same technical effect is achieved, the base station is not limited to a specified technical term. It should be noted that, in this application, only a base station in an NR system is used as an example, and a specific type of the base station is not limited.

The core network device may include but is not limited to at least one of the following: a core network node, a core network function, a mobility management entity (Mobility Management Entity, MME), an access and mobility management function (Access and Mobility Management Function, AMF), a session management function (Session Management Function, SMF), a user plane function (User Plane Function, UPF), a policy control function (Policy Control Function, PCF), a policy and charging rules function unit (Policy and Charging Rules Function, PCRF), an edge application service discovery function (Edge Application Server Discovery Function, EASDF), unified data management (Unified Data Management, UDM), unified data repository (Unified Data Repository, UDR), a home subscriber server (Home Subscriber Server, HSS), centralized network configuration (Centralized network configuration, CNC), a network repository function (Network Repository Function, NRF), a network exposure function (Network Exposure Function, NEF), a local NEF (Local NEF or L-NEF), a binding support function (Binding Support Function, BSF), an application function (Application Function, AF), and the like. It should be noted that, in the embodiments of this application, only a core network device in an NR system is used as an example for description, and a specific type of the core network device is not limited.

For ease of understanding a signal transmission method according to the embodiments of this application, the following related technologies are first described.

### 1. Backscatter Communication (Backscatter Communication, BSC) and Ultra-Low Power-Consuming Communication

The backscatter communication refers to that a backscatter communication device uses a radio frequency signal in another device or environment to perform signal modulation, to transmit information (For example as shown in FIG. 2). The backscatter communication device may be one of the following:
Type 1: a backscatter communication device in conventional RFID, which is usually a Tag, and belongs to a passive-IoT (Passive-IoT) device;
Type 2: a semi-passive (semi-passive) Tag, where this type of Tag has a specific amplification ability for downlink reception or uplink reflection; and
Type 3: a Tag with an active sending capability, that is, an active Tag (active Tag), where this type of terminal may actively generate a carrier signal and send information to a 5G base station (the next Generation NodeB, gNB) or the Reader without relying on reflection for an incident signal.

As shown in FIG. 3, a simple manner to realize backscatter communication is to reflect an incident carrier signal when the Tag needs to send ‘1’, and not to reflect the incident carrier signal when the Tag needs to send ‘0’. Herein, TX BB in FIG. 3 represents a baseband module of a network side device at a transmit end, RX BB represents a baseband processing module of the network side device at a receive end, Logic represents a logic unit, Clock represents a clock unit, Demod represents a demodulator, and RF harvester represents an energy storage module of the Tag.

In addition, the backscatter communication device controls a reflection coefficient Γ of a circuit by adjusting internal impedance of the backscatter communication device, to change an amplitude, a frequency, a phase, and the like of an incident signal, thereby implementing signal modulation. A reflection coefficient of a signal may be represented as:

Γ=Z₁−Z₀/Z₁+Z₀=|Γ|e^{jθ}^{_{T}}, where
Z₀ represents antenna characteristic impedance, and Z₁ represents load impedance.

It is assumed that the incident signal is Sᵢₙ(t). In this case, an output signal is Sₒᵤₜ(t)=Sᵢₙ(t)|Γ|e^{jθ}^{_{T}}. Therefore, corresponding amplitude modulation, frequency modulation, or phase modulation can be implemented through proper control of the reflection coefficient.

In addition, a maximum power of normal terminal communication is at least 23 dBm, and when the maximum power is extremely lower than this value, such as −20 dBm, it belongs to ultra-low power communication. In this case, a modulation method different from the orthogonal frequency division multiplexing (Orthogonal Frequency Division Multiplexing, OFDM) may need to be used, such as a binary on-off-keying (OOK) modulation method.

### 2. Application Scenario for Backscatter Communication

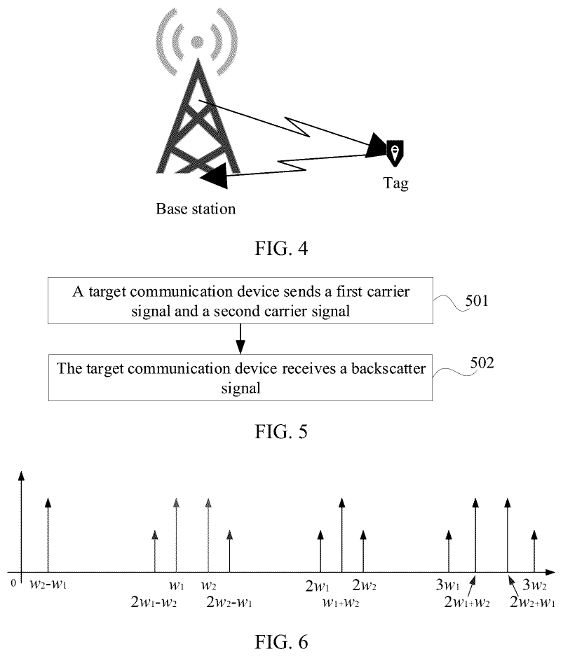

As shown in FIG. 4, a base station (such as a gNB) sends a carrier signal (CW) and signaling to a Tag, where a control type (that is, a type of a control command) includes at least one of the following: select (select), inventory (inventory), and access (access). Then, a network receives feedback information of the Tag.

The following describes in detail the signal transmission method provided in the embodiments of this application through some embodiments and application scenarios thereof with reference to the accompanying drawings.

According to a first aspect, FIG. 5 is a flowchart of a signal transmission method according to an embodiment of this application. The method may include the following step 501 to step 502.

Step 501: A target communication device sends a first carrier signal and a second carrier signal.

A frequency of the first carrier signal is different from a frequency of the second carrier signal. That is, in this embodiment of this application, the target communication device sends the first carrier signal and the second carrier signal that are of different frequencies to a third communication device.

In addition, the signal transmission method in this embodiment of this application is applied to backscatter communication. That is, the target communication device described herein, a first communication device, a second communication device, and a fourth communication device described later may be readers (Reader), and the third communication device may be a Tag device (Tag). For related description of backscatter communication, refer to the foregoing description, and details are not described herein again. Herein, the Reader may be a second network side device (such as a base station) or a terminal.

Optionally, that a target communication device sends a first carrier signal and a second carrier signal includes at least one of the following:
in a case that the target communication device includes a first communication device, simultaneously sending the first carrier signal and the second carrier signal by using the first communication device;
in a case that the target communication device includes a first communication device, sending the first carrier signal at a first time and sending the second carrier signal at a second time by using the first communication device; and
in a case that the target communication device includes a first communication device and a second communication device, sending the first carrier signal by using the first communication device, and sending the second carrier signal by using the second communication device.

Therefore, the first carrier signal and the second carrier signal may be sent by a same communication device or by different communication devices. When the first carrier signal and the second carrier signal are sent by a same first communication device, the first communication device may send the first carrier signal and the second carrier signal at the same time or at different times.

Step 502: The target communication device receives a backscatter signal.

The backscatter signal is obtained based on the first carrier signal and the second carrier signal. That is, in this embodiment of this application, the target communication device may receive the backscatter signal obtained by the third communication device based on the first carrier signal and the second carrier signal.

In addition, after receiving the backscatter signal, the target communication device may filter out an unnecessary signal in the backscatter signal through filtering processing, and then demodulate the signal obtained after filtering.

Optionally, the backscatter signal includes signals obtained after modulating the first carrier signal, the second carrier signal, and a first 3rd order intermodulation IM3 signal and a second IM3 signal that are output after the first carrier signal and the second carrier signal are input to a non-linear component in the third communication device that receives the first carrier signal and the second carrier signal; or
the backscatter signal includes a signal obtained after modulating the first 3rd order intermodulation IM3 signal; or
the backscatter signal includes a signal obtained after modulating the second IM3 signal; or
the backscatter signal includes signals obtained after modulating the first 3rd order intermodulation IM3 signal and the second IM3 signal.

It is assumed that angular frequencies of the first carrier signal and the second carrier signal are w₁ and w₂, and the two carrier frequencies are close. In this case, an input signal vᵢ before passing through the non-linear component can be expressed as: vᵢ=V₀(cos w₁t+cos w₂t), where V₀ is an amplitude of the signal.

The output signal after passing through the non-linear component can be expressed as the following target formula:

$${v}_{0} = {a}_{0} + {a}_{1} {V}_{0} ( cos {w}_{1} t + cos {w}_{2} t ) + {a}_{2} {V}_{0}^{2} {( cos {w}_{1} t + cos {w}_{2} t )}^{2} + {a}_{3} {{V}_{0}^{3} ( cos {w}_{1} t + cos {w}_{2} t )}^{3} + … = {a}_{0} + {a}_{1} {V}_{0} cos {w}_{1} t + {a}_{1} {V}_{0} cos {w}_{2} t + \frac{1}{2} {a}_{2} {V}_{0}^{2} ( 1 + cos 2 {w}_{1} t ) + \frac{1}{2} {a}_{2} {V}_{0}^{2} ( 1 + cos 2 {w}_{2} t ) + {a}_{2} {V}_{0}^{2} cos ( {w}_{1} - {w}_{2} ) t + {a}_{2} {V}_{0}^{2} cos ( {w}_{1} + {w}_{2} ) t + {a}_{3} {V}_{0}^{3} ( \frac{3}{4} cos {w}_{1} t + \frac{1}{4} cos 3 {w}_{1} t ) + {a}_{3} {V}_{0}^{3} ( \frac{3}{4} cos {w}_{2} t + \frac{1}{4} cos 3 {w}_{2} t ) + {a}_{3} {V}_{0}^{3} [ ( \frac{3}{2} cos {w}_{2} t + \frac{3}{4} cos ( 2 {w}_{{1}^{-}} {w}_{2} ) t + \frac{3}{4} cos ( 2 {w}_{1} + {w}_{2} ) t ] + {a}_{3} {V}_{0}^{3} [ ( \frac{3}{2} cos {w}_{1} t + \frac{3}{4} cos ( 2 {w}_{{2}^{-}} {w}_{1} ) t + \frac{3}{4} cos ( 2 {w}_{2} + {w}_{1} ) t ] ,$$

where
a₀, a₁, a₂, and a₃ represent coefficients of different orders. The foregoing formula includes a fundamental wave, a 2nd order intermodulation product and a second-harmonic wave, and a 3rd order intermodulation product and a third-harmonic wave. A specific spectrum distribution diagram is shown in FIG. 6.

Therefore, the third communication device receiving the first carrier signal and the second carrier signal may generate the first 3rd order intermodulation IM3 signal and the second IM3 signal after inputting the first carrier signal and the second carrier signal to the non-linear component in the third communication device respectively. In this case, the third communication device may modulate the first carrier signal, the second carrier signal, the first 3rd order intermodulation IM3 signal, and the second IM3 signal to obtain backscatter signals, and may also modulate the first 3rd order intermodulation IM3 signal and/or the second IM3 signal to obtain the backscatter signals/signal.

The third communication device modulates the first carrier signal, the second carrier signal, the first 3rd order intermodulation IM3 signal, and the second IM3 signal, or modulates the first IM3 intermodulation signal and/or the second IM3 signal, to obtain more backscatter signals with different parameters. For example, when frequency modulation is performed, a backscatter signal with a wider frequency range and far from frequencies of the first carrier signal and the second carrier signal may be obtained. In this way, after the target communication device receives such the backscatter signal, even if there is a self-interference signal in a process of processing the backscatter signal, a band-pass filter may be used to filter out the self-interference signal with greater probability in the process of filtering out the unnecessary signal in the backscatter signal.

In addition, it can be seen from FIG. 6 that the 2nd order intermodulation product, the second-harmonic wave, and the third-harmonic wave are far away from the fundamental wave, while 3rd order intermodulation signals (2w₁−w₂ and 2w₂−w₁) are close to the fundamental wave, which is easy to be detected by the receive end and different from the frequency of the carrier signal. In addition, it can be seen from the foregoing target formula that signal energy of the 3rd order intermodulation signal may be combined and supplemented by using energy of several items, and an energy range thereof is adjustable and controllable to a specific extent. Therefore, 2w₁−w₂ and 2w₂−w₁ in the 3rd order intermodulation signal may be selected as the first 3rd order intermodulation IM3 signal and the second IM3 signal.

It can be learned from the foregoing step 501 to step 502 that, in this embodiment of this application, the target communication device sends the first carrier signal and the second carrier signal, and receives the backscatter signal obtained based on the first carrier signal and the second carrier signal, where the frequency of the first carrier signal is different from the frequency of the second carrier signal. Therefore, in this embodiment of this application, the target communication device may send two carrier signals with different frequencies, so that a device receiving the two carrier signals may generate a backscatter signal based on the two carrier signals.

When the backscatter signal is generated based on the two carrier signals with different frequencies, at least one backscatter signal with a frequency different from that of the two sent carrier signals may be obtained, or a plurality of backscatter signals including at least one backscatter signal with a frequency different from that of the two sent carrier signals and a backscatter signal with a same frequency as the carrier signal may be obtained when the carrier signals with different frequencies pass through the non-linear component. Therefore, after the target communication device receives the backscatter signal, even if there is a self-interference signal in the process of processing the backscatter signal, the self-interference signal may be filtered out with greater probability in the process of filtering out the unnecessary signal in the backscatter signal. Moreover, in this embodiment of this application, no self-interference cancellation circuit is added. Therefore, in this embodiment of this application, the probability of filtering out the self-interference signal may be increased without increasing hardware costs.

Optionally, in a case that the target communication device includes the first communication device, first information is indicated by the first communication device, or specified by a protocol, or configured by a first network side device, where
the first information includes at least one of the following A-1 to A-10:
A-1: a carrier frequency of the first carrier signal;
A-2: a carrier frequency of the second carrier signal;
A-3: a carrier frequency resource of the first carrier signal;
A-4: a carrier frequency resource of the second carrier signal;
A-5: an absolute value of a difference between a carrier frequency of the first carrier signal and a carrier frequency of the second carrier signal;
A-6: a transmit power of the first carrier signal;
A-7: a transmit power of the second carrier signal;
A-8: a 3rd order intermodulation distortion corresponding to a non-linear component in the first communication device;
A-9: a continuous sending time of the first carrier signal; and
A-10: a continuous sending time of the second carrier signal.

In A-2, the carrier frequency resource may include at least one of a frequency location and a frequency resource unit.

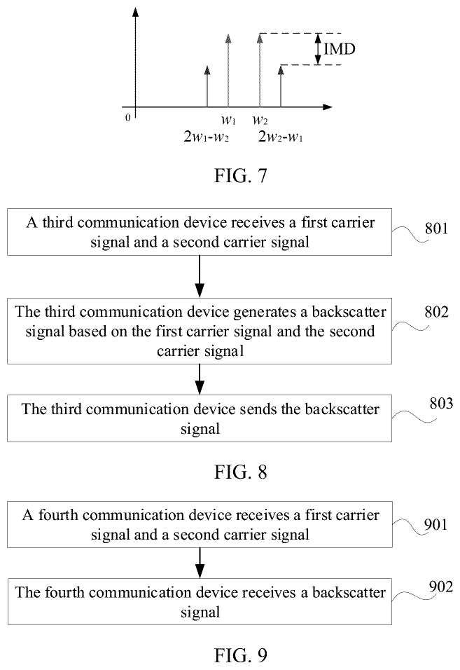

In A-8, the 3rd order intermodulation distortion (3rd order intermodulation distortion, IMD) is an energy difference between a 3rd order intermodulation signal and a fundamental useful signal. For example, after a first carrier signal and a second carrier signal with angular frequencies of w₁ and w₂ are input to a non-linear component, 3rd order intermodulation signals with angular frequencies of 2w₁−w₂ and 2w₂−w₁ are generated. In this case, an IMD corresponding to the non-linear component is shown in FIG. 7, that is, IMD=P₀(w₂)−P₀(2w₂−w₁). P₀(w₂) represents a power of the second carrier signal, and P₀(2w₂−w₁) represents a power of a 3rd order intermodulation signal with an angular frequency of 2w₂−w₁.

Generally, a larger IMD indicates smaller influence of the 3rd order intermodulation signal on a fundamental signal (namely, the first carrier signal and the second carrier signal).

In addition, when the non-linear component is a power amplifier (Power Amplifier, PA), an input power, a bias voltage, or a frequency of an input signal of the PA may affect efficiency and an output power of the PA, thus further affecting a degree of an IMD corresponding to the PA.

Optionally, in a case that the target communication device includes the first communication device and the second communication device, second information is indicated by the first communication device to the second communication device, or specified by a protocol, or configured by a first network side device, where
the second information includes at least one of the following B-1 to B-7:
B-1: the first communication device and the second communication device keep synchronous or asynchronous;
B-2: a carrier frequency of the second carrier signal;
B-3: a carrier frequency resource of the second carrier signal;
B-4: an absolute value of a difference between a carrier frequency of the first carrier signal and a carrier frequency of the second carrier signal;
B-5: a transmit power of the second carrier signal;
B-6: a 3rd order intermodulation distortion corresponding to a non-linear component in the second communication device; and
B-7: a continuous sending time of the second carrier signal.

In B-3, the carrier frequency resource may include at least one of a frequency location and a frequency resource unit.

Therefore, when the first carrier signal and the second carrier signal are sent by the first communication device and the second communication device respectively, the first communication device may indicate the second information to the second communication device, or the second information is specified by a protocol or configured by the first network side device.

Optionally, in a case that the target communication device includes the first communication device and the second communication device, third information is indicated by the second communication device to the first communication device, or specified by a protocol, or configured by the first network side device, where
the third information includes at least one of the following C-1 to C-7:
C-1: the first communication device and the second communication device keep synchronous or asynchronous;
C-2: a carrier frequency of the first carrier signal;
C-3: a carrier frequency resource of the first carrier signal;
C-4: an absolute value of a difference between a carrier frequency of the first carrier signal and a carrier frequency of the second carrier signal;
C-5: a transmit power of the first carrier signal;
C-6: a 3rd order intermodulation distortion corresponding to a non-linear component in the first communication device; and
C-7: a continuous sending time of the first carrier signal.

In C-3, the carrier frequency resource may include at least one of a frequency location and a frequency resource unit.

Therefore, when the first carrier signal and the second carrier signal are sent by the first communication device and the second communication device respectively, alternatively, the second communication device may indicate the second information to the first communication device, or the third information is specified by a protocol or configured by the first network side device.

Optionally, fourth information is indicated by the target communication device to the third communication device, or specified by a protocol, or configured by the first network side device, where
the fourth information includes at least one of the following D-1 to D-3:
D-1: a modulation mode of the backscatter signal;
D-2: a shift of a frequency of the backscatter signal relative to a frequency of a modulation carrier signal; and
D-3: a condition that parameter of the backscatter signal transmission is required to meet.

In D-1, the modulation mode of the backscatter signal includes at least one of amplitude modulation, phase modulation, and frequency modulation.

In D-2, the modulation carrier signal is a signal to be modulated. For example, when the first carrier signal is used as the modulation carrier signal, the “shift” mentioned in D-2 may include: a shift between frequencies of the first carrier signal and a backscatter signal obtained after modulating the first carrier signal; when the second carrier signal is used as the modulation carrier signal, the “shift” mentioned in D-2 may include: a shift between frequencies of the second carrier signal and a backscatter signal obtained after modulating the second carrier signal; when the first 3rd order intermodulation IM3 signal is used as the modulation carrier signal, the “shift” mentioned in D-2 may include: a shift between frequencies of the first 3rd order intermodulation IM3 signal and a backscatter signal obtained after modulating the first 3rd order intermodulation IM3 signal; and when the second IM3 signal is used as the modulation carrier signal, the “shift” mentioned in D-2 may include a shift between frequencies of the second IM3 signal and a backscatter signal obtained after modulating the second IM3 signal.

In addition, it should be noted that when the first carrier signal and the second carrier signal are sent by the first communication device, the fourth information may be indicated by the first communication device to the third communication device; and when the first carrier signal and the second carrier signal are sent by the first communication device and the second communication device respectively, the fourth information may be indicated to the third communication device by at least one of the first communication device and the second communication device.

Optionally, in D-3, the condition that the parameter of the backscatter signal transmission is required to meet includes at least one of the following E-1 to E-6:
E-1: the first carrier signal, the second carrier signal, a first 3rd order intermodulation IM3 signal, and a second IM3 signal are used as the modulation carrier signals;
E-2: the first 3rd order intermodulation IM3 signal is used as the modulation carrier signal;
E-3: the second IM3 signal is used as the modulation carrier signal;
E-4: the first 3rd order intermodulation IM3 signal and the second IM3 signal are used as the modulation carrier signals;
E-5: the shift of the frequency of the backscatter signal relative to the frequency of the modulation carrier signal is less than or equal to a second threshold; and
E-6: a difference between a 3rd order intermodulation distortion corresponding to a non-linear component in the third communication device and a first preset value is less than or equal to a first threshold, where
the first 3rd order intermodulation IM3 signal and the second IM3 signal are respectively IM3 signals that are output after a first carrier signal and a second carrier signal received by the third communication device are input to the non-linear component in the third communication device.

In addition, E-1 indicates that it may be specified by a protocol, or configured by the first network side device, or indicated by the target communication device that the third communication device modulates the first carrier signal, the second carrier signal, the first 3rd order intermodulation IM3 signal, and the second IM3 signal. In this case, the backscatter signal received by the target communication device includes signals obtained after modulating the first carrier signal, the second carrier signal, a first 3rd order intermodulation IM3 signal that is output after the first carrier signal is input to a non-linear component in the third communication device that receives the first carrier signal, and a second IM3 signal that is output after the second carrier signal is input to the non-linear component in the third communication device.

E-2 indicates that it may be specified by a protocol, or configured by the first network side device, or indicated by the target communication device that the third communication device modulates the first 3rd order intermodulation IM3 signal. In this case, the backscatter signal received by the target communication device includes a signal obtained after modulating the first 3rd order intermodulation IM3 signal.

E-3 indicates that it may be specified by a protocol, or configured by the first network side device, or indicated by the target communication device that the third communication device modulates the second IM3 signal. In this case, the backscatter signal received by the target communication device includes a signal obtained after modulating the second IM3 signal.

E-4 indicates that it may be specified by a protocol, or configured by the first network side device, or indicated by the target communication device that the third communication device modulates the first 3rd order intermodulation IM3 signal and the second IM3 signal. In this case, the backscatter signal received by the target communication device includes signals obtained after modulating the first 3rd order intermodulation IM3 signal and the second IM3 signal.

The second threshold in E-5 may be half of the absolute value of the difference between the frequency of the first carrier signal and the frequency of the second carrier signal. The shift of the frequency of the backscatter signal relative to the frequency of the modulation carrier signal is set to be less than or equal to the second threshold, to ensure that the modulated backscatter signal may not cause interference to an adjacent channel signal.

E-6 indicates that it may be specified by a protocol, or configured by the first network side device, or indicated by the target communication device that a difference between a 3rd order intermodulation distortion corresponding to a non-linear component in the third communication device and a first preset value is less than or equal to a first threshold. Herein, E-6 may be used to make the IMD corresponding to the non-linear component in the third communication device as small as possible, so that after the first carrier signal and the second carrier signal are input to the non-linear component in the third communication device, powers of the obtained 3rd order intermodulation signals (namely, the first 3rd order intermodulation IM3 signal and the second IM3 signal) are large. In this way, when the IM3 signal is used as the modulation signal, the target communication device may better receive the signal obtained after modulating the IM3 signal.

Optionally, the method further includes:
receiving, by the target communication device, capability information sent by a third communication device, where
the capability information includes at least one of the following:
whether a non-linear component is integrated; and
capability information of the non-linear component.

Therefore, the third communication device may further send the capability information thereof to the target communication device, to inform the target communication device whether the non-linear component is integrated and/or the capability information of the integrated non-linear component, so that the target communication device can determine, based on the capability information sent by the third communication device, the condition that the parameter of the backscatter signal transmission is required to meet and/or can indicate the information described above for the third communication device.

Optionally, the capability information of the non-linear component includes at least one of the following F-1 to F-3:
F-1: a 3rd order intermodulation distortion corresponding to a non-linear component in the third communication device;
F-2: a maximum power reduction (MPR) corresponding to a non-linear component in the third communication device; and
F-3: a bandwidth corresponding to a non-linear component in the third communication device.

F-1 represents an IMD that can be achieved by the non-linear component in the third communication device.

Optionally, the capability information of the non-linear component may further include a power of an input third-order intercept point (Input Third-order Intercept Point, IIP3) corresponding to the non-linear component in the third communication device. The IIP3 reflects a linear characteristic of the amplifier, and this value is related to the input power and the IMD.

According to a second aspect, FIG. 8 is a flowchart of a signal transmission method according to an embodiment of this application. The method may include the following step 801 to step 803.

Step 801: A third communication device receives a first carrier signal and a second carrier signal.

A frequency of the first carrier signal is different from a frequency of the second carrier signal. That is, in this embodiment of this application, the third communication device may receive the first carrier signal and the second carrier signal that are of different frequencies and that are sent by a target communication device.

In addition, the signal transmission method in this embodiment of this application is applied to backscatter communication. That is, the third communication device herein may be a tag device (Tag); and the target communication device may be a reader (Reader). For related description of backscatter communication, refer to the foregoing description, and details are not described herein again. Herein, the Reader may be a second network side device (such as a base station) or a terminal.

Step 802: The third communication device generates a backscatter signal based on the first carrier signal and the second carrier signal.

Optionally, step 802 “The third communication device generates a backscatter signal based on the first carrier signal and the second carrier signal” includes:
performing, by the third communication device based on an indication of the target communication device, or based on a specification of a protocol, or based on a configuration of a first network side device, at least one of the following:
modulating the first carrier signal, the second carrier signal, a first 3rd order intermodulation IM3 signal, and a second IM3 signal, to obtain the backscatter signal;
modulating the first 3rd order intermodulation IM3 signal, to obtain the backscatter signal;
modulating the second IM3 signal, to obtain the backscatter signal; and
modulating the first 3rd order intermodulation IM3 signal and the second IM3 signal, to obtain the backscatter signal, where
the first 3rd order intermodulation IM3 signal and the second IM3 signal are respectively IM3 signals that are output after a first carrier signal and a second carrier signal received by the third communication device are input to the non-linear component in the third communication device.

Therefore, the backscatter signal includes signals obtained after modulating the first carrier signal, the second carrier signal, and a first 3rd order intermodulation IM3 signal and a second IM3 signal that are output after the first carrier signal and the second carrier signal are input to a non-linear component in the third communication device; or
the backscatter signal includes a signal obtained after modulating the first 3rd order intermodulation IM3 signal; or
the backscatter signal includes a signal obtained after modulating the second IM3 signal; or
the backscatter signal includes signals obtained after modulating the first 3rd order intermodulation IM3 signal and the second IM3 signal.

Therefore, the third communication device receiving the first carrier signal and the second carrier signal may generate the first 3rd order intermodulation IM3 signal and the second IM3 signal after inputting the first carrier signal and the second carrier signal to the non-linear component in the third communication device respectively. In this case, the third communication device may modulate the first carrier signal, the second carrier signal, the first 3rd order intermodulation IM3 signal, and the second IM3 signal to obtain backscatter signals, and may also modulate the first 3rd order intermodulation IM3 signal and/or the second IM3 signal to obtain the backscatter signals/signal.

The third communication device modulates the first carrier signal, the second carrier signal, the first 3rd order intermodulation IM3 signal, and the second IM3 signal, or modulates the first IM3 intermodulation signal and/or the second IM3 signal, to obtain more backscatter signals with different parameters. For example, when frequency modulation is performed, a backscatter signal with a wider frequency range and far from frequencies of the first carrier signal and the second carrier signal may be obtained. In this way, after the target communication device receives such the backscatter signal, even if there is a self-interference signal in a process of processing the backscatter signal, a band-pass filter may be used to more conveniently filter out the self-interference signal with greater probability in the process of filtering out the unnecessary signal in the backscatter signal.

Step 803: The third communication device sends the backscatter signal.

It can be learned from the foregoing step 801 to step 803 that, in this embodiment of this application, the third communication device can receive the first carrier signal and the second carrier signal, obtain the backscatter signal based on the first carrier signal and the second carrier signal, and send the backscatter signal, where the frequency of the first carrier signal is different from the frequency of the second carrier signal. Therefore, in this embodiment of this application, the target communication device may send two carrier signals with different frequencies, so that the third communication device may receive the two carrier signals, and generate the backscatter signal based on the two carrier signals. Moreover, in this embodiment of this application, the third communication device passively receives and processes the carrier signal without additional signaling parse and signaling interaction.

When the backscatter signal is generated based on the two carrier signals with different frequencies, at least one backscatter signal with a frequency different from that of the two sent carrier signals may be obtained, or a plurality of backscatter signals including at least one backscatter signal with a frequency different from that of the two sent carrier signals and a backscatter signal with a same frequency as the carrier signal may be obtained when the carrier signals with different frequencies pass through the non-linear component. Therefore, after the target communication device receives the backscatter signal, even if there is a self-interference signal in the process of processing the backscatter signal, the self-interference signal may be filtered out with greater probability in the process of filtering out the unnecessary signal in the backscatter signal. Moreover, in this embodiment of this application, no self-interference cancellation circuit is added. Therefore, in this embodiment of this application, the probability of filtering out the self-interference signal may be increased without increasing hardware costs.

Optionally, that a third communication device receives a first carrier signal and a second carrier signal includes at least one of the following:
simultaneously receiving, by the third communication device, the first carrier signal and the second carrier signal; and
receiving, by the third communication device, the first carrier signal at a first time and receiving the first carrier signal and the second carrier signal at a second time.

The first carrier signal and the second carrier signal may be sent by a same communication device or by different communication devices. When the first carrier signal and the second carrier signal are sent by a same first communication device, the first communication device may send the first carrier signal and the second carrier signal at the same time or at different times. Therefore, when receiving the first carrier signal and the second carrier signal, the third communication device may simultaneously receive the first carrier signal and the second carrier signal, or may receive the first carrier signal and the second carrier signal at different times.

Optionally, the parameter of the backscatter signal transmission meets at least one of the following conditions G-1 to G-2:
G-1: a difference between a 3rd order intermodulation distortion corresponding to a non-linear component in the third communication device and a first preset value is less than or equal to a first threshold; and
G-2: the shift of the frequency of the backscatter signal relative to the frequency of the modulation carrier signal is less than or equal to a second threshold.

Herein, the condition that the parameter of the backscatter signal transmission meet may be indicated to the third communication device by the target communication device, specified in advance by a protocol, or configured by the first network side device.

In addition, the second threshold may be half of the absolute value of the difference between the frequency of the first carrier signal and the frequency of the second carrier signal.

In addition, G-2 may be used to make the IMD corresponding to the non-linear component in the third communication device as small as possible, so that after the first carrier signal and the second carrier signal are input to the non-linear component in the third communication device, powers of the obtained 3rd order intermodulation signals (namely, the first 3rd order intermodulation IM3 signal and the second IM3 signal) are large. In this way, when the IM3 signal is used as the modulation signal, the target communication device may better receive the signal obtained after modulating the IM3 signal.

Optionally, the method further includes:
sending, by the third communication device, capability information, where
the capability information includes at least one of the following:
whether a non-linear component is integrated; and
capability information of the non-linear component.

Therefore, the third communication device may further send the capability information thereof to the target communication device, to inform the target communication device whether the non-linear component is integrated and/or the capability information of the integrated non-linear component, so that the target communication device can determine, based on the capability information sent by the third communication device, the condition that the parameter of the backscatter signal transmission is required to meet and/or can indicate the information described above for the third communication device.

Optionally, the capability information of the non-linear component includes at least one of the following F-1 to F-3:
F-1: a 3rd order intermodulation distortion corresponding to a non-linear component in the third communication device;
F-2: a maximum power reduction (MPR) corresponding to a non-linear component in the third communication device; and
F-3: a bandwidth corresponding to a non-linear component in the third communication device.

F-1 represents an IMD that can be achieved by the non-linear component in the third communication device.

Optionally, the capability information of the non-linear component may further include a power of an input third-order intercept point (Input Third-order Intercept Point, IIP3) corresponding to the non-linear component in the third communication device. The IIP3 reflects a linear characteristic of the amplifier, and this value is related to the input power and the IMD.

According to a third aspect, FIG. 9 is a flowchart of a signal transmission method according to an embodiment of this application. The method may include the following step 901 to step 902.

Step 901: A fourth communication device receives a first carrier signal and a second carrier signal.

A frequency of the first carrier signal is different from a frequency of the second carrier signal. That is, the fourth communication device may receive the first carrier signal and the second carrier signal that are of different frequencies and that are sent by a target communication device.

Step 902: The fourth communication device receives a backscatter signal.

The backscatter signal is obtained based on the first carrier signal and the second carrier signal. That is, the fourth communication device may receive the backscatter signal obtained by the third communication device based on the first carrier signal and the second carrier signal.

It can be learned from step 901 to step 902 that, the fourth communication device may receive the first carrier signal and the second carrier signal sent by the target communication device, and the backscatter signal obtained by the third communication device based on the first carrier signal and the second carrier signal. That is, the signal transmission method in this embodiment of this application may further be applied to a bistatic architecture.

In the bistatic architecture of the prior art, a receive end (such as UE) may receive a carrier signal of a transmit end (such as gNB) and a backscatter signal of Tag. Because an energy of the backscatter signal is far lower than that of the carrier signal, the receive end may fail to demodulate the backscatter signal.

However, in a case that the communication method in this embodiment of this application is applied to the bistatic architecture, when generating the backscatter signal based on two carrier signals with different frequencies, the third communication device may obtain at least one backscatter signal in a frequency different from that of the two sent carrier signals, or may obtain a plurality of backscatter signals such as at least one backscatter signal in a frequency different from that of the two sent carrier signals and a backscatter signal in the same frequency as the carrier signal. Therefore, if a co-frequency interference of the backscatter signal obtained in this way is small, the fourth communication device may successfully parse the backscatter signal more easily after receiving the backscatter signal, the first carrier signal, and the second carrier signal, that is, when the communication method in this embodiment of this application is applied to the bistatic architecture, a success rate of parsing the backscatter signal by the fourth communication device can be improved.

In addition, it should be noted that the first network side device and the second network side device may be the same or may be different.

In conclusion, a specific implementation of the signal transmission method in this embodiment of this application may be described in the following Implementation 1 or Implementation 2.

### Implementation 1: A Same Reader Sends Two Carrier Signals

First, it should be noted that in this implementation, an example in which a non-linear component in the Reader includes one PA and two band-pass filters, and a non-linear component in the Tag includes one low noise amplifier (Low Noise Amplifier, LNA) is used for description, but it does not mean that the communication method in this embodiment of this application is applied to only this type of Reader and Tag.

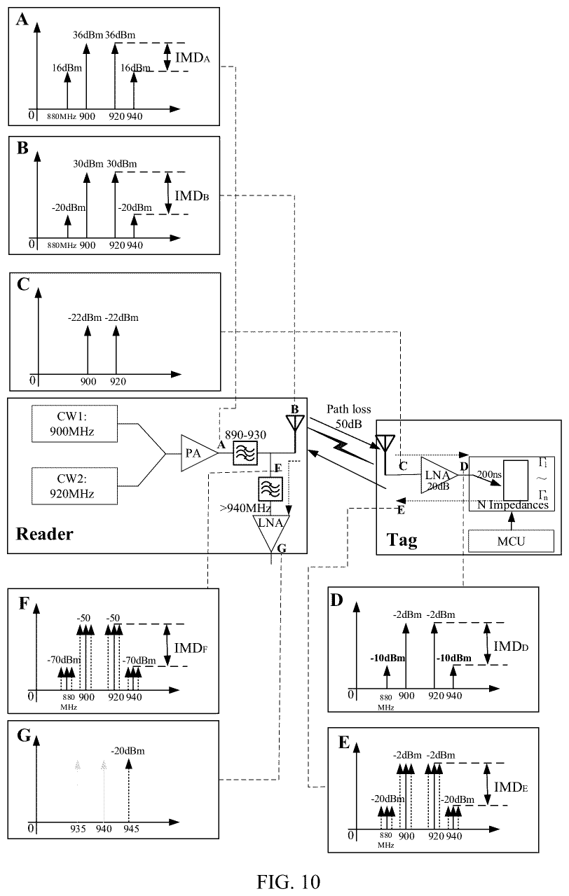

The following parameter values in (1.1) to (1.5) on a Reader side are given through predefinition or network configuration:
(1.1) Frequency information of two carrier signals (CW) (namely, CW1 and CW2 in FIG. 10);
the frequency information may include, for example, that frequencies of the first carrier signal (CW1) and the second carrier signal (CW2) are 900 MHz and 920 MHz respectively; or the carrier frequency of CW1 is 900 MHz, and a frequency difference between CW1 and CW2 is 20 MHz;
(1.2) Frequency domain resources of two carriers;
(1.3) IMD1 (that is, an IMD corresponding to the non-linear component in the Reader, such as IMD_{A} and IMD_{B} in FIG. 10);
it should be noted herein that an input power, a bias voltage, or a frequency of an input signal of the PA may affect efficiency and an output power of the PA, thus further affecting a degree of an IMD corresponding to the PA. IMD_{B} in FIG. 10 is controlled by using the band-pass filter, and its value is fixed;
(1.4) Duration T of CW1 and CW2; and
(1.5) Powers of CW1 and CW2, for example, are both 36 dBm.

In addition, the following parameters in 2.1 to 2.3 are indicated to the Tag or predefined by using the Reader:
(2.1) Modulation mode of the Tag (in this embodiment, double sideband amplitude shift keying (DSB-ASK) modulation is used as an example);
(2.2) Frequency shift Δf of the backscatter signal relative to the modulation carrier signal, and Δf<|f1−f2|/2, where f1 represents a frequency of CW1, and f2 represents a frequency of CW2; and
(2.3) IMD2, that is, an IMD corresponding to the non-linear component in the Tag, such as IMD_{D} and IMD_{E} in FIG. 10.

The bias voltage/input power/signal frequency of the LNA may affect the efficiency of the LNA and further affect an output power thereof, so that a degree of IMD2 may be further controlled.

In addition, a signal processing procedure in the Reader is described in the following 3.1.

(3.1) As shown in FIG. 10, local oscillators of the Reader generate two carrier signals respectively, namely, CW1: 900 MHz and CW2: 902 MHz, where after passing through a PA in the Reader, it can be seen from a spectrum diagram of point A that IMD_{A} is 20 dB. Then, after the two carrier signals and two IM3 signals (namely, signals with frequencies of 880 MHz and 940 MHz) pass through a band-pass filter of 890 MHz to 930 MHz, powers of the carrier signals remain basically unchanged at 30 dBm, and powers of the IM3 signals drop to −20 dBm (as shown in a spectrum diagram of point B). Then the carrier signals and the IM3 signals are transmitted through a transmit antenna of the Reader. After that, the transmitted carrier signals and IM3 signals are received by the Tag after 50 dB of path loss. The powers of the two carrier signals received by the Tag are both −22 dBm, as shown in a spectrum diagram of point C, and frequencies are 900 MHz and 920 MHz respectively.

Then, a signal modulation procedure in the Tag is described in the following 3.2.

(3.2) During downlink transmission, the two carrier signals pass through the LNA of the Tag, where powers of the two carrier signals are increased from −22 dBm to −2 dBm after being amplified by the LNA, and due to the non-linear characteristic of the LNA, IM3 signals of −10 dBm are generated at frequency points of 880 MHz and 940 MHz. In this case, IMD_{D} is 8 dB (as shown in a spectrum diagram of point D). Then, the Tag modulates the two carrier signals and the two IM3 signals in a DSB-ASK modulation manner, thus generating modulation data (namely, the backscatter signal) near the two carrier frequencies and the two IM3 signals, with a frequency shift of 5 MHz. It can be understood that a frequency-shift keying (Frequency-shift keying, FSK) modulation manner may also be used to modulate the two carrier signals and the two IM3 signals, to obtain the backscatter signal. If the DSB-ASK modulation manner is used, an obtained backscatter signal is shown by a dotted line in a spectrum diagram of point E and signals represented by 880 MHz and 940 MHz. If the FSK modulation manner is used, the obtained backscatter signal is shown by the dotted line in the spectrum diagram of point E.

After that, a reverse transmission procedure of the signal is described in the following 3.3.

(3.3) The modulated backscatter signal is attenuated by 50 dB in an uplink wireless channel, and is received by a receiving antenna of the Reader, as shown in a spectrum diagram of point F. In this case, the power of the carrier signal and a power of modulation data thereof (namely, signals indicated by two dashed lines on both sides of 900 MHz and signals indicated by two dashed lines on both sides of 920 MHz in the spectrum diagram of point F) are about −50 dBm, and a power of the IM3 signal and a power of modulation data thereof (namely, signals indicated by two dashed lines on both sides of 880 MHz and signals indicated by two dashed lines on both sides of 940 MHz in the spectrum diagram of point F) are about −70 dBm. Then, after these signals pass through a band-pass filter of “>940 MHz” in the Reader and the LAN, only a backscatter signal of 945 MHz is left as shown in a spectrum diagram of point G.

In the Reader shown in FIG. 10, CW1 and CW2 may enter the band-pass filter of “>940 MHz”, thus causing self-interference in processing the backscatter signal received by the Reader, that is, the CW1 and CW2 signals entering the band-pass filter of “>940 MHz” herein belong to self-interference signals.

It can be seen from the above procedure that, by generating the IM3 signal on the Tag side and modulating the IM3 signal, frequencies of signals obtained by modulating the IM3 signal (namely, signals indicated by two dashed lines on both sides of 880 MHz and signals indicated by two dashed lines on both sides of 940 MHz in the spectrum diagram of point F) are far away from the frequencies of CW1 and CW2 (namely, 900 MHz and 920 MHz). After receiving the backscatter signal, the Reader may keep only one or several of the modulated signals. For example, only a signal indicated by the dashed line on the right side of 940 MHz in the spectrum diagram of point F (namely, 945 MHz) may be kept, and other signals are filtered out. In this way, after the signal shown in the spectrum diagram of point F is input to the band-pass filter of “>940 MHz”, a signal less than or equal to 940 MHz may be filtered out. In this way, not only other unnecessary IM3 signals may be filtered, but also the self-interference signals (namely, the two carrier signals CW1 and CW2) may be filtered out.

Therefore, in this implementation, by generating the IM3 signal on the Tag side and modulating the IM3 signal, the Reader may filter out other unnecessary signals, including the two carrier signals and the unnecessary IM3 signal, after receiving the backscatter signal (namely, the modulated signal), to achieve the purpose of interference elimination.

It should be noted that the methods for calculating the frequencies of the IM3 signals are as follows:
880 MHz=2*frequency of CW1−frequency of CW2; and
940 MHz=2*frequency of CW2−frequency of CW1.

In addition, the band-pass filter of 890 MHz to 930 MHz in the Reader may not only play a filtering role, but also may reduce the power of the IM3 signal that is output from the PA (that is, the signals of 880 MHz and 940 MHz in the spectrum diagram of point A), so that when the Reader transmits the signal, the Tag may receive cleaner carrier signals of 900 MHz and 920 MHz.

In addition, IMD_{A} in the Reader is set to be larger (namely, greater than a specific threshold), for example, set to be 20 dB in this implementation, so that the power of the IM3 signal in the spectrum diagram of point A is smaller, and when the Reader transmits the signal, the Tag may receive a cleaner carrier signal of 900 MHz and 920 MHz.

IMD_{D} is set to be smaller in the Tag (namely, less than a specific threshold), for example, set to be 8 dB in this implementation, so that the power of the IM3 signal in the spectrum diagram of point D is greater, and when the IM3 signal is used as the modulation signal, the Reader may better receive a signal obtained by modulating the IM3 signal.

### Implementation 2: Different Readers Send Two Carrier Signals

First, it should be noted that in this implementation, an example in which a non-linear component in the first Reader includes one PA and two band-pass filters, a non-linear component in the second Reader includes one PA and one band-pass filter, and a non-linear component in the Tag includes one LNA is used for description, but it does not mean that the communication method in this embodiment of this application is applied to only this type of Reader and Tag.

Secondly, in this implementation, the first Reader sends a first carrier signal, and the second Reader sends a second carrier signal.

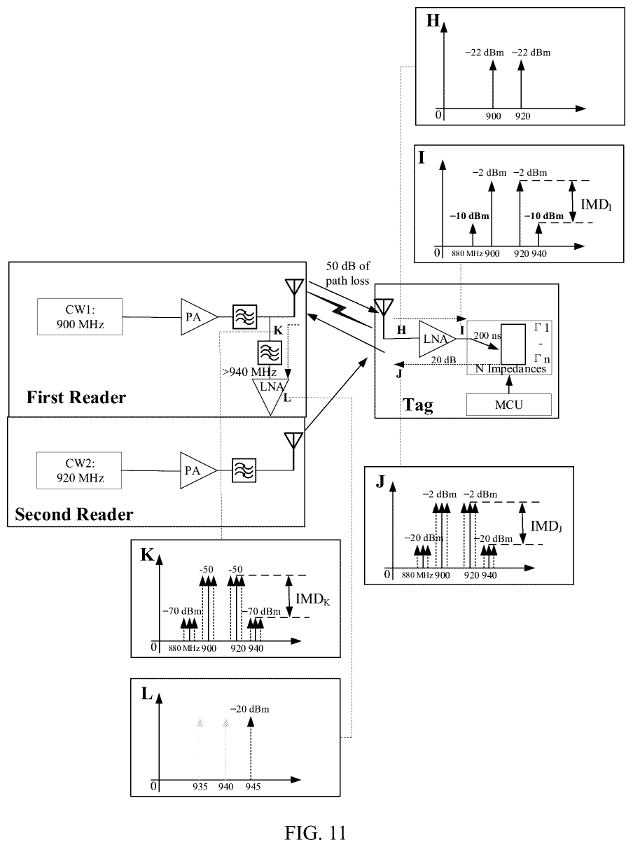

Moreover, similar to Implementation 1, the following parameter values in (1.1) to (1.6) on a first Reader side and a second Reader side are given through predefinition or network configuration:
(1.1) Frequency information of two carrier signals (CW) (namely, CW1 and CW2 in FIG. 11);
the frequency information may include, for example, that the frequencies of CW1 and CW2 are 900 MHz and 920 MHz respectively; or the carrier frequency of CW1 is 900 MHz, and a frequency difference between CW1 and CW2 is 20 MHz;
(1.2) Frequency domain resources of two carriers;
(1.3) IMD corresponding to a non-linear component in a first Reader;
(1.4) IMD corresponding to a non-linear component in a second Reader;
(1.5) Duration T of CW1 and CW2;
(1.6) Powers of CW1 and CW2, for example, are both 36 dBm; and
(1.7) The first Reader and the second Reader keep synchronization.

It can be understood that the first Reader may also indicate the following parameters in (2.1) to (2.6) to the second Reader:
(2.1) Frequency of a second carrier signal;
(2.2) Frequency domain resource of a second carrier signal;
(2.3) IMD corresponding to a non-linear component in a second Reader;
(2.4) Duration of the second carrier signal;
(2.5) Transmit power of the second carrier signal; and
(2.6) The first Reader and the second Reader keep synchronization.

It can be understood that the second Reader may also indicate the following parameters in (3.1) to (3.6) to the first Reader:
(3.1) Frequency of the first carrier signal;
(3.2) Frequency domain resource of the first carrier signal;
(3.3) IMD corresponding to a non-linear component in the first Reader;
(3.4) Duration of the first carrier signal;
(3.5) Transmit power of the first carrier signal; and
(3.6) The first Reader and the second Reader keep synchronization.

In addition, the following parameters in 4.1 to 4.3 are indicated to the Tag or predefined by using the first Reader and/or the second Reader;
(4.1) Modulation mode of the Tag (in this embodiment, double sideband amplitude shift keying (DSB-ASK) modulation is used as an example);
(4.2) Frequency shift Δf of the backscatter signal relative to the modulation signal, and Δf<|f1−f2|/2, where f1 represents a frequency of CW1, and f2 represents a frequency of CW2; and
(4.3) IMD2, that is, an IMD corresponding to the non-linear component in the Tag, such as IMD_{I} and IMD_{J} in FIG. 11.

The bias voltage of the LNA in the Tag may be controlled to affect the output power of the non-linear component, to further control the degree of IMD2.

As shown in FIG. 11, carrier signals transmitted by the first Reader and the second Reader are received by the Tag after a path loss of 50 dB, where powers of the two carrier signals received by the Tag are both −22 dBm, as shown in a spectrum diagram of point H, and frequencies are 900 MHz and 902 MHz respectively.

It should be noted herein that the spectrum diagram of point H gives a case in which the powers of the two carrier signals received by Tag are equal, and there is also a case in which the powers are not equal. Herein, the powers of the two carrier signals received by the Tag are different, which is mainly caused by different channel attenuation degrees and different distances between the first Reader and the Tag and between the second Reader and the Tag.

Herein, regardless of whether the powers of the two carrier signals received by the Tag are the same, a subsequent Tag signal modulation procedure and reverse transmission procedure are consistent with that in Implementation 1. Moreover, a processing procedure in which the backscatter signal transmitted by the Tag is received by the first Reader after channel attenuation is consistent with that in Implementation 1.

Implementation 1 and Implementation 2 may also be extended to the bistatic architecture, that is, the backscatter signal may also be received by a third Reader; and the third Reader also receives a carrier signal sent to the Tag by the first Reader and/or the second reader.

In the bistatic architecture of the prior art, a receive end (such as UE) may receive a carrier signal of a transmit end (such as gNB) and a backscatter signal of Tag. Because an energy of the backscatter signal is far lower than that of the carrier signal, the receive end may fail to demodulate the backscatter signal.

However, after Implementation 1 or Implementation 2 is extended to the bistatic architecture, the frequency of the backscatter signal generated by the Tag is far from the frequency of the carrier signal, so that the co-frequency interference is very small, and the third Reader may more easily parse the backscatter signal successfully after receiving the backscatter signal, the first carrier signal, and the second carrier signal, that is, Implementation 1 or Implementation 2 is extended to the bistatic architecture, to improve a success rate of the third Reader in parsing the backscatter signal.

The signal transmission method provided in this embodiment of this application may be executed by a signal transmission apparatus. In this embodiment of this application, that the signal transmission apparatus performs the signal transmission method is used as an example to describe the signal transmission apparatus provided in this embodiment of this application.

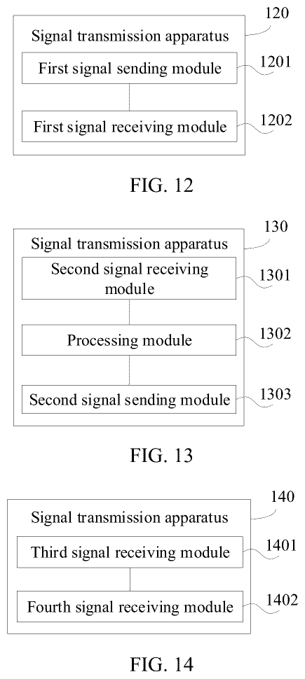

According to a fourth aspect, an embodiment of this application provides a signal transmission apparatus, which may be applied to a target communication device. As shown in FIG. 12, the signal transmission apparatus 120 includes the following modules:
a first signal sending module 1201, configured to send a first carrier signal and a second carrier signal, where a frequency of the first carrier signal is different from a frequency of the second carrier signal; and
a first signal receiving module 1202, configured to receive a backscatter signal, where the backscatter signal is obtained based on the first carrier signal and the second carrier signal.

Optionally, the first signal sending module 1201 is configured to perform at least one of the following:
in a case that the target communication device includes a first communication device, controlling the first communication device to simultaneously send the first carrier signal and the second carrier signal;
in a case that the target communication device includes a first communication device, controlling the first communication device to send the first carrier signal at a first time and send the second carrier signal at a second time; and
in a case that the target communication device includes a first communication device and a second communication device, controlling the first communication device to send the first carrier signal, and sending the second carrier signal by using the second communication device.

Optionally, in a case that the target communication device includes the first communication device, first information is indicated by the first communication device, or specified by a protocol, or configured by a first network side device, where
the first information includes at least one of the following:
a carrier frequency of the first carrier signal;
a carrier frequency of the second carrier signal;
a carrier frequency resource of the first carrier signal;
a carrier frequency resource of the second carrier signal;
an absolute value of a difference between a carrier frequency of the first carrier signal and a carrier frequency of the second carrier signal;
a transmit power of the first carrier signal;
a transmit power of the second carrier signal;
a 3rd order intermodulation distortion corresponding to a non-linear component in the first communication device;
a continuous sending time of the first carrier signal; and
a continuous sending time of the second carrier signal.

Optionally, in a case that the target communication device includes the first communication device and the second communication device, second information is indicated by the first communication device to the second communication device, or specified by a protocol, or configured by a first network side device, where
the second information includes at least one of the following:
the first communication device and the second communication device keep synchronous or asynchronous;
a carrier frequency of the second carrier signal;
a carrier frequency resource of the second carrier signal;
an absolute value of a difference between a carrier frequency of the first carrier signal and a carrier frequency of the second carrier signal;
a transmit power of the second carrier signal;
a 3rd order intermodulation distortion corresponding to a non-linear component in the second communication device; and
a continuous sending time of the second carrier signal.

Optionally, in a case that the target communication device includes the first communication device and the second communication device, third information is indicated by the second communication device to the first communication device, or specified by a protocol, or configured by the first network side device, where
the third information includes at least one of the following:
the first communication device and the second communication device keep synchronous or asynchronous;
a carrier frequency of the first carrier signal;
a carrier frequency resource of the first carrier signal;
an absolute value of a difference between a carrier frequency of the first carrier signal and a carrier frequency of the second carrier signal;
a transmit power of the first carrier signal;
a 3rd order intermodulation distortion corresponding to a non-linear component in the first communication device; and
a continuous sending time of the first carrier signal.

Optionally, fourth information is indicated by the target communication device to the third communication device, or specified by a protocol, or configured by the first network side device, where
the fourth information includes at least one of the following:
a modulation mode of the backscatter signal;
a shift of a frequency of the backscatter signal relative to a frequency of a modulation carrier signal; and
a condition that parameter of the backscatter signal transmission is required to meet.

Optionally, the modulation mode of the backscatter signal includes at least one of the following:
amplitude modulation, phase modulation, and frequency modulation.

Optionally, the condition that the parameter of the backscatter signal transmission is required to meet includes at least one of the following:
the first carrier signal, the second carrier signal, a first 3rd order intermodulation IM3 signal, and a second IM3 signal are used as the modulation carrier signals;
the first 3rd order intermodulation IM3 signal is used as the modulation carrier signal;
the second IM3 signal is used as the modulation carrier signal;
the first 3rd order intermodulation IM3 signal and the second IM3 signal are used as the modulation carrier signals;
the shift of the frequency of the backscatter signal relative to the frequency of the modulation carrier signal is less than or equal to a second threshold; and
a difference between a 3rd order intermodulation distortion corresponding to the non-linear component in the third communication device and a first preset value is less than or equal to a first threshold, where
the first 3rd order intermodulation IM3 signal and the second IM3 signal are respectively IM3 signals that are output after a first carrier signal and a second carrier signal received by the third communication device are input to a non-linear component in the third communication device.

Optionally, the apparatus further includes:
a capability information receiving module, configured to receive capability information sent by a third communication device, where
the capability information includes at least one of the following:
whether a non-linear component is integrated; and
capability information of the non-linear component.

Optionally, the capability information of the non-linear component includes at least one of the following:
a 3rd order intermodulation distortion corresponding to a non-linear component in the third communication device;
a maximum power reduction corresponding to a non-linear component in the third communication device; and
a bandwidth corresponding to a non-linear component in the third communication device.

Optionally, the target communication device is a second network side device or a terminal.

The signal transmission apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (Network Attached Storage, NAS), or the like. This is not specifically limited in this embodiment of this application.

The signal transmission apparatus provided in this embodiment of this application can implement the processes implemented in the method embodiment in FIG. 5, and a same technical effect is achieved. To avoid repetition, details are not described herein again.

According to a fifth aspect, an embodiment of this application provides a signal transmission apparatus, which may be applied to a third communication device. As shown in FIG. 13, the signal transmission apparatus 130 includes the following modules:
a second signal receiving module 1301, configured to receive a first carrier signal and a second carrier signal, where a frequency of the first carrier signal is different from a frequency of the second carrier signal;
a processing module 1302, configured to generate a backscatter signal based on the first carrier signal and the second carrier signal; and
a second signal sending module 1303, configured to send the backscatter signal.

Optionally, the second signal receiving module 1301 is configured to perform at least one of the following:
simultaneously receiving the first carrier signal and the second carrier signal; and
receiving the first carrier signal at a first time and receiving the first carrier signal and the second carrier signal at a second time.

Optionally, the processing module 1302 is specifically configured to:
perform, based on an indication of the target communication device, or based on a specification of a protocol, or based on a configuration of a first network side device, at least one of the following:
modulating the first carrier signal, the second carrier signal, a first 3rd order intermodulation IM3 signal, and a second IM3 signal, to obtain the backscatter signal;
modulating the first 3rd order intermodulation IM3 signal, to obtain the backscatter signal;
modulating the second IM3 signal, to obtain the backscatter signal; and
modulating the first 3rd order intermodulation IM3 signal and the second IM3 signal, to obtain the backscatter signal, where
the first 3rd order intermodulation IM3 signal and the second IM3 signal are respectively IM3 signals that are output after a first carrier signal and a second carrier signal received by the third communication device are input to a non-linear component in the third communication device.

Optionally, the parameter of the backscatter signal transmission meets at least one of the following conditions:
a difference between a 3rd order intermodulation distortion corresponding to the non-linear component in the third communication device and a first preset value is less than or equal to a first threshold; and
a shift of a frequency of the backscatter signal relative to a frequency of a modulation carrier signal is less than or equal to a second threshold.

Optionally, the apparatus further includes:
a capability information sending module, configured to send capability information, where
the capability information includes at least one of the following:
whether a non-linear component is integrated; and
capability information of the non-linear component.

Optionally, the capability information of the non-linear component includes at least one of the following:
a 3rd order intermodulation distortion corresponding to a non-linear component in the third communication device;
a maximum power reduction corresponding to a non-linear component in the third communication device; and
a bandwidth corresponding to a non-linear component in the third communication device.

The signal transmission apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (Network Attached Storage, NAS), or the like. This is not specifically limited in this embodiment of this application.

The signal transmission apparatus provided in this embodiment of this application can implement the processes implemented in the method embodiment in FIG. 8, and a same technical effect is achieved. To avoid repetition, details are not described herein again.

According to a sixth aspect, an embodiment of this application provides a signal transmission apparatus, which may be applied to a fourth communication device. As shown in FIG. 14, the signal transmission apparatus 140 includes the following modules:
a third signal receiving module 1401, configured to receive a first carrier signal and a second carrier signal, where a frequency of the first carrier signal is different from a frequency of the second carrier signal; and
a fourth signal receiving module 1402, configured to receive a backscatter signal, where the backscatter signal is obtained based on the first carrier signal and the second carrier signal.

The signal transmission apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (Network Attached Storage, NAS), or the like. This is not specifically limited in this embodiment of this application.

The signal transmission apparatus provided in this embodiment of this application can implement the processes implemented in the method embodiment in FIG. 9, and a same technical effect is achieved. To avoid repetition, details are not described herein again.

Optionally, as shown in FIG. 15, an embodiment of this application further provides a communication device 1500, including a processor 1501 and a memory 1502. The memory 1502 stores a program or an instruction that can be run on the processor 1501. For example, when the communication device 1500 is a terminal, the program or the instruction is executed by the processor 1501 to implement the steps of the foregoing signal transmission method embodiments, and a same technical effect can be achieved. In a case that the communication device 1500 is a network side device, when the program or the instruction is executed by the processor 1501, the steps of the foregoing signal transmission method embodiments are implemented, and a same technical effect can be achieved. To avoid repetition, details are not described herein again.

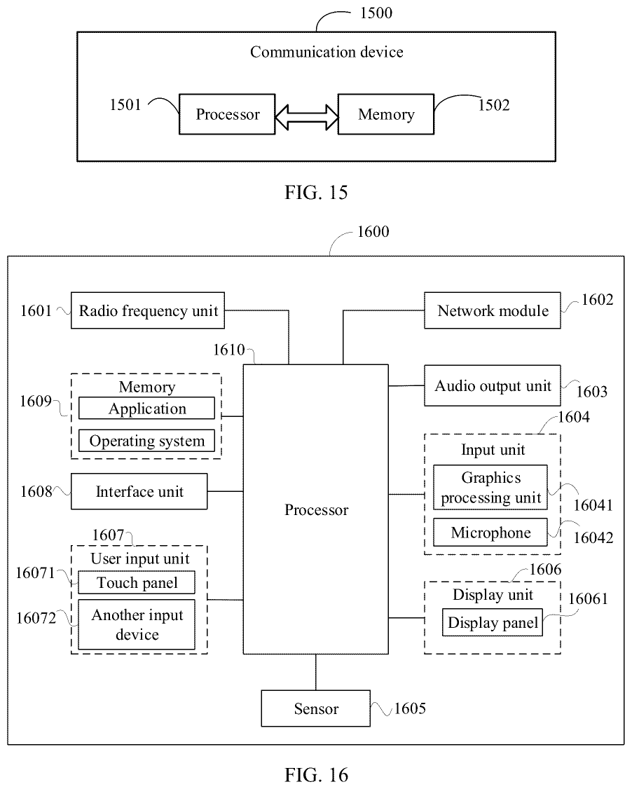

An embodiment of this application further provides a terminal. FIG. 16 is a schematic diagram of a hardware structure of a terminal according to an embodiment of this application.

The terminal 1600 includes but is not limited to at least a part of components such as a radio frequency unit 1601, a network module 1602, an audio output unit 1603, an input unit 1604, a sensor 1605, a display unit 1606, a user input unit 1607, an interface unit 1608, a memory 1609, and a processor 1610.

A person skilled in the art can understand that the terminal 1600 may further include a power supply (such as a battery) that supplies power to each component. The power supply may be logically connected to the processor 1610 by using a power supply management system, to implement functions such as charging and discharging management, and power consumption management by using the power supply management system. The terminal structure shown in FIG. 16 constitutes no limitation on the terminal, and the terminal may include more or fewer components than those shown in the figure, or combine some components, or have different component arrangements. Details are not described herein.

It should be understood that in this embodiment of this application, the input unit 1604 may include a graphics processing unit (Graphics Processing Unit, GPU) 16041 and a microphone 16042. The graphics processing unit 16041 processes image data of a static picture or a video obtained by an image capture apparatus (for example, a camera) in a video capture mode or an image capture mode. The display unit 1606 may include a display panel 16061, and the display panel 16061 may be configured in a form of a liquid crystal display, an organic light-emitting diode, or the like. The user input unit 1607 includes at least one of a touch panel 16071 and another input device 16072. The touch panel 16071 is also referred to as a touchscreen. The touch panel 16071 may include two parts: a touch detection apparatus and a touch controller. The another input device 16072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1601 may transmit the downlink data to the processor 1610 for processing. In addition, the radio frequency unit 1601 may send uplink data to the network side device. Generally, the radio frequency unit 1601 includes but is not limited to an antenna, an amplifier, a transceiver, a coupler, a low noise amplifier, a duplexer, and the like.

The memory 1609 may be configured to store a software program or an instruction and various data. The memory 1609 may mainly include a first storage area for storing a program or an instruction and a second storage area for storing data. The first storage area may store an operating system, and an application or an instruction required by at least one function (for example, a sound playing function or an image playing function). In addition, the memory 1609 may be a volatile memory or a non-volatile memory, or the memory 1609 may include a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 1609 in this embodiment of this application includes but is not limited to these memories and any memory of another proper type.

The processor 1610 may include one or more processing units. Optionally, an application processor and a modem processor are integrated into the processor 1610. The application processor mainly processes an operating system, a user interface, an application, and the like. The modem processor mainly processes a wireless communication signal, for example, a baseband processor. It may be understood that, alternatively, the modem processor may not be integrated into the processor 1610.

When the terminal 1600 is used as the target communication device, the radio frequency unit 1601 is configured to: send a first carrier signal and a second carrier signal, where a frequency of the first carrier signal is different from a frequency of the second carrier signal; and receive a backscatter signal, where the backscatter signal is obtained based on the first carrier signal and the second carrier signal.

Optionally, that the radio frequency unit 1601 sends a first carrier signal and a second carrier signal includes at least one of the following:
in a case that the target communication device includes a first communication device, controlling the first communication device to simultaneously send the first carrier signal and the second carrier signal;
in a case that the target communication device includes a first communication device, controlling the first communication device to send the first carrier signal at a first time and send the second carrier signal at a second time; and
in a case that the target communication device includes a first communication device and a second communication device, controlling the first communication device to send the first carrier signal, and sending the second carrier signal by using the second communication device.

Optionally, in a case that the target communication device includes the first communication device, first information is indicated by the first communication device, or specified by a protocol, or configured by a first network side device, where
the first information includes at least one of the following:
a carrier frequency of the first carrier signal;
a carrier frequency of the second carrier signal;
a carrier frequency resource of the first carrier signal;
a carrier frequency resource of the second carrier signal;
an absolute value of a difference between a carrier frequency of the first carrier signal and a carrier frequency of the second carrier signal;
a transmit power of the first carrier signal;
a transmit power of the second carrier signal;
a 3rd order intermodulation distortion corresponding to a non-linear component in the first communication device;
a continuous sending time of the first carrier signal; and
a continuous sending time of the second carrier signal.

Optionally, in a case that the target communication device includes the first communication device and the second communication device, second information is indicated by the first communication device to the second communication device, or specified by a protocol, or configured by a first network side device, where
the second information includes at least one of the following:
the first communication device and the second communication device keep synchronous or asynchronous;
a carrier frequency of the second carrier signal;
a carrier frequency resource of the second carrier signal;
an absolute value of a difference between a carrier frequency of the first carrier signal and a carrier frequency of the second carrier signal;
a transmit power of the second carrier signal;
a 3rd order intermodulation distortion corresponding to a non-linear component in the second communication device; and
a continuous sending time of the second carrier signal.

Optionally, in a case that the target communication device includes the first communication device and the second communication device, third information is indicated by the second communication device to the first communication device, or specified by a protocol, or configured by the first network side device, where
the third information includes at least one of the following:
the first communication device and the second communication device keep synchronous or asynchronous;
a carrier frequency of the first carrier signal;
a carrier frequency resource of the first carrier signal;
an absolute value of a difference between a carrier frequency of the first carrier signal and a carrier frequency of the second carrier signal;
a transmit power of the first carrier signal;
a 3rd order intermodulation distortion corresponding to a non-linear component in the first communication device; and
a continuous sending time of the first carrier signal.

Optionally, fourth information is indicated by the target communication device to the third communication device, or specified by a protocol, or configured by the first network side device, where
the fourth information includes at least one of the following:
a modulation mode of the backscatter signal;
a shift of a frequency of the backscatter signal relative to a frequency of a modulation carrier signal; and
a condition that parameter of the backscatter signal transmission is required to meet.

Optionally, the modulation mode of the backscatter signal includes at least one of the following:
amplitude modulation, phase modulation, and frequency modulation.

Optionally, the condition that the parameter of the backscatter signal transmission is required to meet includes at least one of the following:
the first carrier signal, the second carrier signal, a first 3rd order intermodulation IM3 signal, and a second IM3 signal are used as the modulation carrier signals;
the first 3rd order intermodulation IM3 signal is used as the modulation carrier signal;
the second IM3 signal is used as the modulation carrier signal;
the first 3rd order intermodulation IM3 signal and the second IM3 signal are used as the modulation carrier signals;
the shift of the frequency of the backscatter signal relative to the frequency of the modulation carrier signal is less than or equal to a second threshold; and
a difference between a 3rd order intermodulation distortion corresponding to the non-linear component in the third communication device and a first preset value is less than or equal to a first threshold, where
the first 3rd order intermodulation IM3 signal and the second IM3 signal are respectively IM3 signals that are output after a first carrier signal and a second carrier signal received by the third communication device are input to a non-linear component in the third communication device.

Optionally, the radio frequency unit 1601 is further configured to:
receive capability information sent by the third communication device, where
the capability information includes at least one of the following:
whether a non-linear component is integrated; and
capability information of the non-linear component.

Optionally, the capability information of the non-linear component includes at least one of the following:
a 3rd order intermodulation distortion corresponding to a non-linear component in the third communication device;
a maximum power reduction corresponding to a non-linear component in the third communication device; and
a bandwidth corresponding to a non-linear component in the third communication device.

Optionally, the target communication device is a second network side device or a terminal.

When the terminal 1600 is used as a fourth communication device, the radio frequency unit 1601 is configured to: receive a first carrier signal and a second carrier signal, where a frequency of the first carrier signal is different from a frequency of the second carrier signal; and receive a backscatter signal, where the backscatter signal is obtained based on the first carrier signal and the second carrier signal.

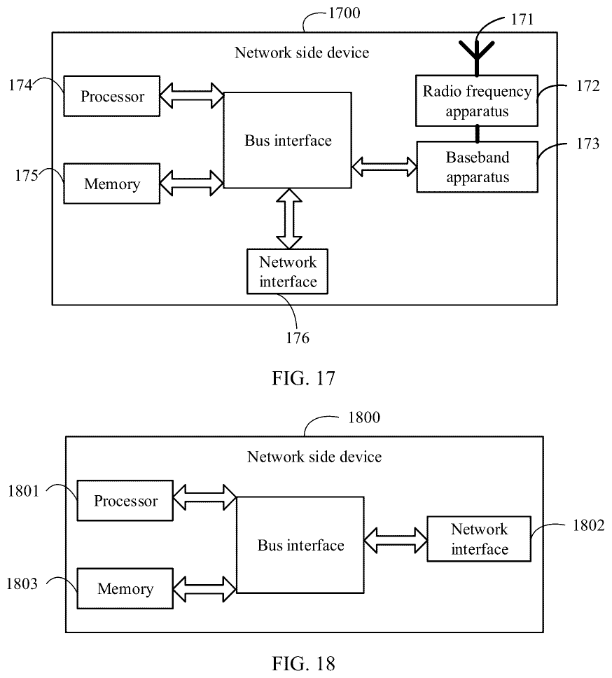

An embodiment of this application further provides a network side device. As shown in FIG. 17, the network side device 1700 includes an antenna 171, a radio frequency apparatus 172, a baseband apparatus 173, a processor 174, and a memory 175. The antenna 171 is connected to the radio frequency apparatus 172. In an uplink direction, the radio frequency apparatus 172 receives information through the antenna 171, and sends the received information to the baseband apparatus 173 for processing. In a downlink direction, the baseband apparatus 173 processes information that needs to be sent, and sends processed information to the radio frequency apparatus 172. The radio frequency apparatus 172 processes the received information, and sends processed information through the antenna 171.

In the foregoing embodiment, the method performed by the network side device may be implemented in the baseband apparatus 173. The baseband apparatus 173 includes a baseband processor.

For example, the baseband apparatus 173 may include at least one baseband board. A plurality of chips are disposed on the baseband board. As shown in FIG. 17, one chip is, for example, a baseband processor, and is connected to the memory 175 by using a bus interface, to invoke a program in the memory 175 to perform the operations of the network device shown in the foregoing method embodiment.

The network side device may further include a network interface 176, and the interface is, for example, a common public radio interface (common public radio interface, CPRI).

Specifically, the network side device 1700 in this embodiment of the present invention further includes an instruction or a program that is stored in the memory 175 and that can be run on the processor 174. The processor 174 invokes the instruction or the program in the memory 175 to perform the method shown in FIG. 5 or FIG. 9, and a same technical effect is achieved. To avoid repetition, details are not described herein again.

Specifically, an embodiment of this application further provides a network side device. As shown in FIG. 18, a network side device 1800 includes a processor 1801, a network interface 1802, and a memory 1803. The network interface 1802 is, for example, a common public radio interface (common public radio interface, CPRI).

Specifically, the network side device 1800 in this embodiment of the present invention further includes an instruction or a program that is stored in the memory 1803 and that can be run on the processor 1801. The processor 1801 invokes the instruction or the program in the memory 1803 to perform the method shown in FIG. 5 or FIG. 9, and a same technical effect is achieved. To avoid repetition, details are not described herein again.

An embodiment of this application further provides a readable storage medium. The readable storage medium stores a program or an instruction, and when the program or the instruction is executed by a processor, the processes of the signal transmission method embodiments according to the first aspect, the second aspect, or the third aspect are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, the processor is configured to run a program or an instruction to implement the processes of the signal transmission method embodiments according to the first aspect, the second aspect, or the third aspect, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, the computer program/program product is executed by at least one processor to implement the processes of the signal transmission method embodiments according to the first aspect, the second aspect, or the third aspect, and a same technical effect can be achieved. To avoid repetition, details are not described herein again.

An embodiment of this application further provides a signal transmission system, including a target communication device, a third communication device, and a fourth communication device. The target communication device may be configured to perform the steps of the signal transmission method according to the first aspect, the third communication device may be configured to perform the steps of the signal transmission method according to the second aspect, and the fourth communication device may be configured to perform the steps of the signal transmission method according to the third aspect.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the implementations of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a desirable implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A signal transmission method, wherein the method comprises:
sending, by a target communication device, a first carrier signal and a second carrier signal, wherein a frequency of the first carrier signal is different from a frequency of the second carrier signal; and
receiving, by the target communication device, a backscatter signal, wherein the backscatter signal is obtained based on the first carrier signal and the second carrier signal.

2. The method according to claim 1, wherein the sending, by a target communication device, a first carrier signal and a second carrier signal comprises at least one of the following:
in a case that the target communication device comprises a first communication device, simultaneously sending the first carrier signal and the second carrier signal by using the first communication device;
in a case that the target communication device comprises a first communication device, sending the first carrier signal at a first time and sending the second carrier signal at a second time by using the first communication device; and
in a case that the target communication device comprises a first communication device and a second communication device, sending the first carrier signal by using the first communication device, and sending the second carrier signal by using the second communication device.

3. The method according to claim 1, wherein in a case that the target communication device comprises the first communication device, first information is indicated by the first communication device, or specified by a protocol, or configured by a first network side device, wherein
the first information comprises at least one of the following:
a carrier frequency of the first carrier signal;
a carrier frequency of the second carrier signal;
a carrier frequency resource of the first carrier signal;
a carrier frequency resource of the second carrier signal;
an absolute value of a difference between a carrier frequency of the first carrier signal and a carrier frequency of the second carrier signal;
a transmit power of the first carrier signal;
a transmit power of the second carrier signal;
a 3rd order intermodulation distortion corresponding to a non-linear component in the first communication device;
a continuous sending time of the first carrier signal; and
a continuous sending time of the second carrier signal.

4. The method according to claim 1, wherein in a case that the target communication device comprises the first communication device and the second communication device, second information is indicated by the first communication device to the second communication device, or specified by a protocol, or configured by a first network side device, wherein
the second information comprises at least one of the following:
the first communication device and the second communication device keep synchronous or asynchronous;
a carrier frequency of the second carrier signal;
a carrier frequency resource of the second carrier signal;
an absolute value of a difference between a carrier frequency of the first carrier signal and a carrier frequency of the second carrier signal;
a transmit power of the second carrier signal;
a 3rd order intermodulation distortion corresponding to a non-linear component in the second communication device; and
a continuous sending time of the second carrier signal.

5. The method according to claim 1, wherein in a case that the target communication device comprises the first communication device and the second communication device, third information is indicated by the second communication device to the first communication device, or specified by a protocol, or configured by a first network side device, wherein
the third information comprises at least one of the following:
the first communication device and the second communication device keep synchronous or asynchronous;
a carrier frequency of the first carrier signal;
a carrier frequency resource of the first carrier signal;
an absolute value of a difference between a carrier frequency of the first carrier signal and a carrier frequency of the second carrier signal;
a transmit power of the first carrier signal;
a 3rd order intermodulation distortion corresponding to a non-linear component in the first communication device; and
a continuous sending time of the first carrier signal.

6. The method according to claim 1, wherein fourth information is indicated by the target communication device to a third communication device, or specified by a protocol, or configured by a first network side device, wherein
the fourth information comprises at least one of the following:
a modulation mode of the backscatter signal;
a shift of a frequency of the backscatter signal relative to a frequency of a modulation carrier signal; and
a condition that a parameter for transmission of the backscatter signal is required to meet.

7. The method according to claim 6, wherein the modulation mode of the backscatter signal comprises at least one of the following:
amplitude modulation, phase modulation, and frequency modulation.

8. The method according to claim 6, wherein the condition that the parameter for transmission of the backscatter signal is required to meet comprises at least one of the following:
the first carrier signal, the second carrier signal, a first 3rd order intermodulation IM3 signal, and a second IM3 signal are used as the modulation carrier signals;
the first 3rd order intermodulation IM3 signal is used as the modulation carrier signal;
the second IM3 signal is used as the modulation carrier signal;
the first 3rd order intermodulation IM3 signal and the second IM3 signal are used as the modulation carrier signals;
the shift of the frequency of the backscatter signal relative to the frequency of the modulation carrier signal is less than or equal to a second threshold; and
a difference between a 3rd order intermodulation distortion corresponding to a non-linear component in the third communication device and a first preset value is less than or equal to a first threshold, wherein
the first 3rd order intermodulation IM3 signal and the second IM3 signal are respectively IM3 signals that are output after a first carrier signal and a second carrier signal received by the third communication device are input to the non-linear component in the third communication device.

9. The method according to claim 1, wherein the method further comprises:
receiving, by the target communication device, capability information sent by a third communication device, wherein
the capability information comprises at least one of the following:
whether a non-linear component is integrated; and
capability information of the non-linear component.

10. The method according to claim 9, wherein the capability information of the non-linear component comprises at least one of the following:
a 3rd order intermodulation distortion corresponding to a non-linear component in the third communication device;
a maximum power reduction corresponding to a non-linear component in the third communication device; and
a bandwidth corresponding to a non-linear component in the third communication device.

11. A signal transmission method, wherein the method comprises:
receiving, by a third communication device, a first carrier signal and a second carrier signal, wherein a frequency of the first carrier signal is different from a frequency of the second carrier signal;
generating, by the third communication device, a backscatter signal based on the first carrier signal and the second carrier signal; and
sending, by the third communication device, the backscatter signal.

12. The method according to claim 11, wherein the receiving, by a third communication device, a first carrier signal and a second carrier signal comprises at least one of the following:
simultaneously receiving, by the third communication device, the first carrier signal and the second carrier signal; and
receiving, by the third communication device, the first carrier signal at a first time and receiving the first carrier signal and the second carrier signal at a second time.

13. The method according to claim 11, wherein the generating, by the third communication device, a backscatter signal based on the first carrier signal and the second carrier signal comprises:
performing, by the third communication device based on an indication of the target communication device, or based on a specification of a protocol, or based on a configuration of a first network side device, at least one of the following:
modulating the first carrier signal, the second carrier signal, a first 3rd order intermodulation IM3 signal, and a second IM3 signal, to obtain the backscatter signal;
modulating the first 3rd order intermodulation IM3 signal, to obtain the backscatter signal;
modulating the second IM3 signal, to obtain the backscatter signal; and
modulating the first 3rd order intermodulation IM3 signal and the second IM3 signal, to obtain the backscatter signal, wherein
the first 3rd order intermodulation IM3 signal and the second IM3 signal are respectively IM3 signals that are output after a first carrier signal and a second carrier signal received by the third communication device are input to a non-linear component in the third communication device.

14. The method according to claim 11, wherein a parameter for transmission of the backscatter signal meets at least one of the following conditions:
a difference between a 3rd order intermodulation distortion corresponding to the non-linear component in the third communication device and a first preset value is less than or equal to a first threshold; and
a shift of a frequency of the backscatter signal relative to a frequency of a modulation carrier signal is less than or equal to a second threshold.

15. The method according to claim 11, wherein the method further comprises:
sending, by the third communication device, capability information, wherein
the capability information comprises at least one of the following:
whether a non-linear component is integrated; and
capability information of the non-linear component.

16. The method according to claim 15, wherein the capability information of the non-linear component comprises at least one of the following:
a 3rd order intermodulation distortion corresponding to a non-linear component in the third communication device;
a maximum power reduction corresponding to a non-linear component in the third communication device; and
a bandwidth corresponding to a non-linear component in the third communication device.

17. A signal transmission method, wherein the method comprises:
receiving, by a fourth communication device, a first carrier signal and a second carrier signal, wherein a frequency of the first carrier signal is different from a frequency of the second carrier signal; and
receiving, by the fourth communication device, a backscatter signal, wherein the backscatter signal is obtained based on the first carrier signal and the second carrier signal.

18. A communication terminal, comprising a processor and a memory, wherein the memory stores a program or an instruction executable on the processor, and when the program or the instruction is executed by the processor, the steps of the signal transmission method according claim 1 are implemented.

19. A communication terminal, comprising a processor and a memory, wherein the memory stores a program or an instruction executable on the processor, and when the program or the instruction is executed by the processor, the steps of the signal transmission method according claim 11 are implemented.

20. A communication terminal, comprising a processor and a memory, wherein the memory stores a program or an instruction executable on the processor, and when the program or the instruction is executed by the processor, the steps of the signal transmission method according claim 17 are implemented.
